(19) United States
(12) Patent Application Publication
(10) Pub. No.: US 2023/0141138 A1
(43) Pub. Date: May 11, 2023

(54) PHASE CONTROL IN ADDITIVE MANUFACTURING

(71) Applicants: HEWLETT-PACKARD DEVELOPMENT COMPANY, L.P., Spring, TX (US); NANYANG TECHNOLOGICAL UNIVERSITY, Singapore (SG)

(72) Inventors: Karl Peter Davidson, Singapore (SG); Matteo Seita, Singapore (SG); Shubo Gao, Singapore (SG)

(21) Appl. No.: 17/524,165

(22) Filed: Nov. 11, 2021

(51) Int. Cl. B22F 10/368; B22F 10/28; B22F 12/43; B33Y 10/00; B33Y 30/00

(52) U.S. Cl. CPC B22F 10/368; B22F 10/28; B22F 12/43; B33Y 10/00; B33Y 30/00; B22F 2203/11

(57) ABSTRACT

In one example in accordance with the present disclosure, a method is described. The example method determining parameters for a pulsed laser to generate a melt pool pattern in a three-dimensional (3D) object to produce different phases in the 3D object that vary according to the melt pool pattern. The example method also includes controlling the pulsed laser to form the 3D object in an additive manufacturing process based on the determined parameters and the melt pool pattern.

### BACKGROUND

Three-dimensional (3D) printing is an additive manufacturing process used to make three-dimensional solid parts from a digital model. In some examples, additive manufacturing may be used in rapid product prototyping, mold generation, mold master generation, and short run manufacturing. Some additive manufacturing techniques are considered additive processes because they involve the application of successive layers of material. This is unlike other machining processes, which often rely upon the removal of material to create the final part.

### BRIEF DESCRIPTION OF THE DRAWINGS

The accompanying drawings illustrate various examples of the principles described herein and are part of the specification. The illustrated examples are given merely for illustration, and do not limit the scope of the claims.

FIG. 1 is a block diagram of an additive manufacturing system for phase control in a build material, according to an example.

FIG. 2 illustrates different types of melt pools, according to an example.

FIGS. 3A and 3B illustrate different types of melt pools, according to another example.

FIG. 4 is a flow diagram illustrating a method for phase control in a build material, according to an example.

FIG. 5 is a flow diagram illustrating a method for phase control in a build material, according to another example.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

The present disclosure is drawn to additive manufacturing systems and methods. More particularly, the systems and methods can be used with powder bed fusion (PBF) where a heat source (e.g., a laser, etc.) is used to consolidate a powdered build material to form a 3D object. In some examples, the heat source may be applied to the build material contained within a powder bed to form a layer of the 3D object. Examples of PBF include laser sintering, laser powder bed fusion (LPBF), and pulsed-laser powder bed fusion (pLPBF).

In the case of LPBF, a powdered build material (particulate or powder) is spread on a powder bed support (referred to herein as a build area platform) on a layer-by-layer basis. A laser may be used to selectively melt and sinter the build material together at specific points. This can be repeated layer by layer until a three-dimensional object is formed. Once a layer of the 3D object is completed, the build area platform lowers and more build material is distributed on top of the powder bed for a subsequent layer.

This disclosure describes examples of methods and additive manufacturing systems to site-specifically control the phase content in multi-phase metal alloys (e.g., carbon steel, stainless steel, titanium, etc.) by varying the cooling rate of the build material through melt pool engineering during pulsed-laser powder bed fusion processing. In some examples, pLPBF provides the ability to create and customize the mechanical behavior and other functional properties (e.g., corrosion resistance) of multi-phase alloys at an unprecedented level of detail by controlling the spatial distribution, arrangement, and size of the constituent microstructural phases (e.g., body-centered cubic (BCC) ferrite and face-centered cubic (FCC) austenite, or martensite and BCC ferrite).

The described examples enable generating 3D objects made of alloys such as steel—arguably one of the most ubiquitous alloys in society—with tunable strength, ductility, and corrosion resistance. With other manufacturing approaches, a manufactured object may exhibit randomized phase ratio and distribution. The described examples enable phase control both in-plane (i.e., within each layer of the build material generated during LPBF) as well as out-of-plane (i.e., along the build direction of the 3D object). As such, these examples open the path to completely new microstructure designs, which transcend those offered by approaches involving layer-wise microstructure control. Furthermore, these examples may be applied to control the phase content in a wide range of alloy systems. This latter feature is expected to facilitate new alloy designs for additive manufacturing.

The examples described herein may be used to control the melt pool depth and cooling rate in an LPBF process. In some examples, the phase control enabled by these methods may be achieved by tuning the pulsed-laser parameters to drive the formation of a melt pool pattern in the build material. As used herein the term “melt pool” refers to a volume of build material that is heated by a laser to transition from a solid state to a liquid state. The melt pool then resolidifies as the liquid build material cools. Melt pools may have different characteristics depending on the parameters used by the laser to melt the build material. For example, laser parameters may include the peak power of the laser, the spot size of the laser on the build material, the laser pulse frequency, the laser pulse duration, and the spacing of the laser emissions on the build material. The term “melt pool pattern” refers to an arrangement of melt pools throughout the build material, where melt pools may vary according to the laser parameters.

The present specification describes examples of a method for phase control in a build material. The example method includes determining parameters for a pulsed laser to generate a melt pool pattern in a three-dimensional (3D) object to produce different phases in the 3D object that vary according to the melt pool pattern. The example method also includes controlling the pulsed laser to form the 3D object in an additive manufacturing process based on the determined parameters and the melt pool pattern.

In another example, the present specification describes another example method that includes generating a first melt pool in a first region of a build material with a pulsed laser set to a first set of parameters to control phase properties in the first region. The example method also includes adjusting the pulsed laser to a second set of parameters. The example method further includes generating a second melt pool in a second region of the build material with the pulsed laser set to the second set of parameters to produce phase properties in the second region that differ from the phase properties in the first region.

In yet another example, the present specification describes an additive manufacturing system. In some examples, the additive manufacturing system includes a build material distributor, a pulsed laser, a controller, and a non-transitory computer readable medium having stored thereon computer executable instructions to cause the controller to utilize the build material distributor to dispense the build material in a plurality of layers. The instructions also cause the controller to control the pulsed laser to generate a melt pool pattern in the plurality of layers of the build material to form a 3D object having different phases that vary according to the melt pool pattern.

As used in the present specification and in the appended claims, the term “controller” may be a processor resource, a processor, an application-specific integrated circuit (ASIC), a semiconductor-based microprocessor, a central processing unit (CPU), and a field-programmable gate array (FPGA), and/or other hardware device that executes instructions.

As used in the present specification and in the appended claims, the term “memory” may include a non-transitory computer-readable storage medium, where the computer-readable storage medium may contain, or store computer-usable program code for use by or in connection with an instruction execution system, apparatus, or device. The memory may take many types of memory including volatile memory (e.g., RAM) and non-volatile memory (e.g., ROM).

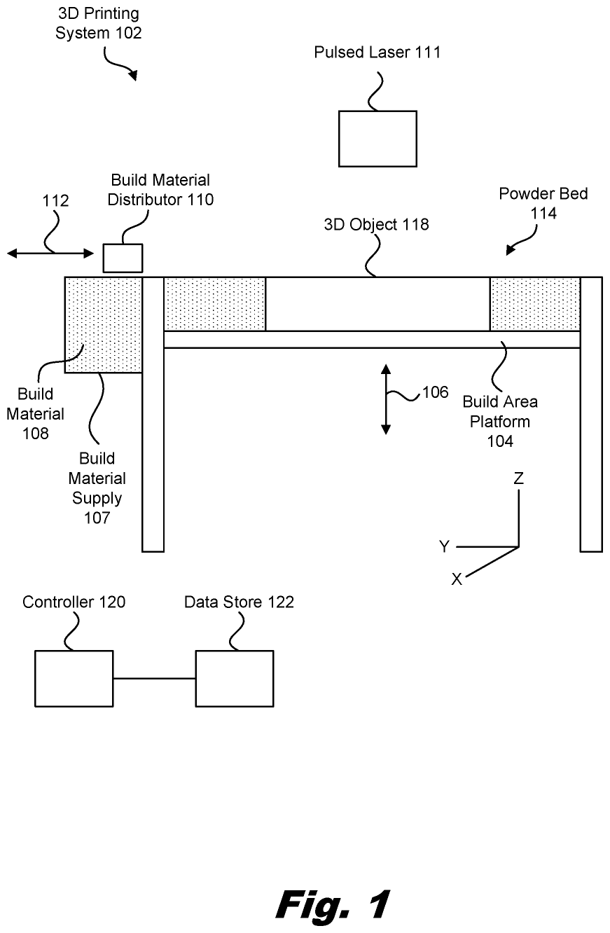

Turning now to the figures, FIG. 1 is a block diagram of an additive manufacturing system 102 for phase control in a build material 108, according to an example. It is to be understood that the additive manufacturing system 102 may include additional components and that some of the components described herein may be removed and/or modified. Furthermore, components of the additive manufacturing system 102 depicted in FIG. 1 may not be drawn to scale and thus, the additive manufacturing system 102 may have a different size and/or configuration other than as shown therein.

The additive manufacturing system 102 includes a build area platform 104, a build material supply 107 containing build material 108, a build material distributor 110, and a pulsed laser 111. In some examples, the build material 108 may be a powdered metal alloy (e.g., carbon steel, stainless steel, titanium, etc.). While the example of a metal alloy is described, other materials may be used for the build material 108. The build material 108 may include a material that can contain multiple phases when in a solid state. As used herein, the term “phase” refers to a physically homogeneous state of matter, where the phase has a given chemical composition, and a distinct type of atomic bonding and arrangement of elements. For a solid material, the phase may be defined by the crystal structure of the elements forming the solid material. For example, one phase of a solid material may have a body-centered cubic (BCC) crystal structure and a second phase of a solid material may have a face-centered cubic (FCC) crystal structure.

In some examples, within an alloy, two or more different phases can be present at the same time. Each phase within an alloy may have distinct physical, mechanical, electrical, and electrochemical properties. For example, in carbon steel, ferrite may be a relatively soft phase and cementite is a hard, brittle phase. When they are present together, the strength of the alloy is much greater than for ferrite and the ductility is much better compared to cementite.

The build area platform 104 receives the build material 108 from the build material supply 107. The build area platform 104 may be integrated with the additive manufacturing system 102 or may be a component that is separately insertable into the additive manufacturing system 102. For example, the build area platform 104 may be a module that is available separately from the additive manufacturing system 102. The build material platform 104 that is shown is also one example, and could be replaced with another support member, such as a platen, a fabrication/print bed, a glass plate, or another build surface.

The build area platform 104 may be moved in a direction 106 as denoted by the arrow oriented along the z-axis, so that build material 108 may be delivered to the build area platform 104 or to a previously formed 3D object layer (i.e., fused build material). In an example, when the build material 108 is to be delivered, the build area platform 104 may be programmed to advance (e.g., downward) enough so that the build material distributor 110 can push the build material 108 onto the build area platform 104 to form a layer of the build material 108 thereon. The build area platform 104 may also be returned to its original position, for example, when a new 3D object 118 is to be built.

The build material supply 107 may be a container, bed, or other surface that is to position the build material 108 between the build material distributor 110 and the build area platform 104. In some examples, the build material supply 107 may include a surface upon which the build material 108 may be supplied, for instance, from a build material source (not shown) located above the build material supply 107. Examples of the build material source may include a hopper, an auger convey er, or the like. In some examples, the build material supply 107 may include a mechanism (e.g., a delivery piston) to provide, e.g., move, the build material 108 from a storage location to a position to be spread onto the build area platform 104 or onto a previously formed 3D object layer.

The build material distributor 110 may be moved in a direction as denoted by the arrow 112, e.g., along the y-axis, over the build material supply 107 and across the build area platform 104 to spread a layer of the build material 108 over the build area platform 104. The build material distributor 110 may also be returned to a position adjacent to the build material supply 107 following the spreading of the build material 108. In some examples, the build material distributor 110 may be a blade (e.g., a doctor blade), a roller, a combination of a roller and a blade, and/or any other device capable of spreading the build material 108 over the build area platform 104. For instance, the build material distributor 110 may be a counterrotating roller.

In some examples, the additive manufacturing system 102 may also include a pulsed laser 111. The pulsed laser 111 may be used to expose the build area platform 104 (and any build material 108 and/or agent(s) thereon) to thermal energy (e.g., electromagnetic radiation) that ultimately fuses and/or sinters the build material 108. The pulsed laser 111 may be a device that emits light through a process of optical amplification based on a stimulated emission of electromagnetic radiation. The pulsed laser 111 may emit a beam of optical energy (e.g., concentrated light) in pulses of a given duration and at a given repetition rate.

In some examples, the beam of the pulsed laser 111 may be positioned on the powder bed 114 using mirrors that direct the beam to a given location along the y-axis and x-axis. As used herein, the term “powder bed” refers to build material 108 that is deposited on the build area platform 104 and contained within side walls of the additive manufacturing system 102. A beam from the pulsed laser 111 may have given energy characteristics based on a number of parameters of the pulsed laser 111. For example, parameters used to adjust the beam characteristics may include the peak power of the laser, the spot size of the laser beam on the build material, the beam focal length (also referred to as focal distance), the laser pulse frequency, and the laser pulse duration.

In some examples, the beam focal length of the pulsed laser 111 may be adjusted by focusing the pulsed laser 111. For example, a first focal length may focus the laser beam emitted by the pulsed laser 111 on a given location of the powder bed surface, which may result in an area on the surface of the powder bed 114 having a high concentration of thermal energy. In another example, a second focal length may result in a diffused laser beam on the surface of the powder bed 114, which may result in a lower concentration of thermal energy on the powder bed surface.

It should be noted that while the example of a mirror to position the laser beam is described, in other examples, the laser beam may be positioned with other mechanisms. For example, the pulsed laser 111 may be mounted an on a track (e.g., a translational carriage) to move across the build area platform 104, e.g., along the y-axis and x-axis. This allows for printing and heating as the pulsed laser 111 passes over the build area platform 104. In some examples, the pulsed laser 111 can make multiple passes over the build area platform 104 depending on the amount of exposure utilized in the method(s) disclosed herein.

Each of these physical elements may be operatively connected to a controller 120 of the additive manufacturing system 102. The controller 120 may control the operations of the build area platform 104, the build material supply 107, the build material distributor 110, and the pulsed laser 111. As an example, the controller 120 may control actuators (not shown) to control various operations of the additive manufacturing system 102 components. The controller 120 may be a computing device, a semiconductor-based microprocessor, a central processing unit (CPU), an application specific integrated circuit (ASIC), and/or another hardware device. Although not shown, the controller 120 may be connected to the additive manufacturing system 102 components via communication lines.

The controller 120 manipulates and transforms data, which may be represented as physical (electronic) quantities within the additive manufacturing system's registers and memories, to control the physical elements to create the 3D object 118. As such, the controller 120 is depicted as being in communication with a data store 122. The data store 122 may include data pertaining a 3D object 118 to be printed by the additive manufacturing system 102. The data store 122 may include data pertaining parameters for the pulsed laser 111 to generate a melt pool pattern in the 3D object 118.

The data store 122 may also include machine readable instructions (stored on a non-transitory computer readable medium) that are to cause the controller 120 to control the amount of build material 108 that is supplied by the build material supply 107, the movement of the build area platform 104, the movement of the build material distributor 110, movement of the pulsed laser 111, adjustments to the pulsed laser parameters, etc.

In some examples, the data store 122 may include computer executable instructions to cause the controller 120 to utilize the build material distributor 110 to dispense the build material 108 in a plurality of layers. For example, the build material distributor 110 may distribute a layer of build material 108 over the build area platform 104.

In some examples, the data store 122 may include computer executable instructions to cause the controller 120 to control the pulsed laser 111 to generate a melt pool pattern in the plurality of layers of the build material 108 to form a 3D object 118 having different phases that vary according to the melt pool pattern. The melt pool pattern may include the type of melt pools generated by the pulsed laser 111. The melt pool pattern may also include the placement of the melt pools within a given layer of the 3D object 118 and through the build direction of the 3D object 118. As used herein, “build direction” refers to the vertical direction (e.g., along the z-axis) that the layers of the 3D object 118 accumulate. In FIG. 1, direction 106 corresponds to the build direction of the 3D object 118. In other words, the build area platform 104 moves along the axis of the build direction.

In some examples, the controller 120 may determine parameters for the pulsed laser 111 to generate a melt pool pattern in the 3D object 118 to produce different phases in the 3D object 118 that vary according to the melt pool pattern. As described above, some examples of parameters for the pulsed laser 111 may include peak power, pulse frequency (e.g., how often the pulse occurs), pulse duration (e.g., how long the pulse lasts), and focal distance (e.g., the focus of the pulse).

In some examples, the parameters for the pulsed laser 111 to produce a melt pool pattern may include the location and characteristics of melt pools on a given layer (referred to as the build plane) of the 3D object 118 within the powder bed 114. This approach may allow for control of phases in the build plane. For example, a first melt pool may be generated at a first location of a build layer with a first set of parameters, while a second melt pool may be generated at a second location of the build layer with a second set of parameters, and so forth.

In some examples, the parameters for the pulsed laser 111 to produce a melt pool pattern may include locations and characteristics of melt pools in different layers of the 3D object 118 within the powder bed 114. This approach may allow for control of phases in different layers in the build direction. For example, a first melt pool may be generated at a location of a first layer with a first set of parameters, while a second melt pool may be generated at a location of a second layer with a second set of parameters, and so forth.

In some examples, the controller 120 may cause the pulsed laser 111 to generate different types of melt pools at different locations through variable cooling rates. For example, the pulsed laser 111 may exhibit higher peak power at low pulse repetition rates than a laser run in continuous mode. The pulsing of the pulsed laser 111 may enable the formation of deep melt pools with high cooling rates. The deepest melt pool may be achieved when the laser beam is in focus. The focused laser beam may remelt multiple underlying layers, which solidify at high cooling rates because of the surrounding dense metal matrix. The use of a focused laser beam to remelt underlying layers is referred to as a keyhole mode and a melt pool generated in this mode may be referred to as a keyhole mode melt pool. The high cooling rates of the keyhole mode favor the formation of metastable phases in the build material 108. It should be noted that other parameters (e.g., peak power, pulse frequency, pulse duration, etc.) may be used to generate keyhole mode melt pools.

In another example approach, defocusing the beam of the pulsed laser 111 may yield shallower melt pools. The use of a defocused beam may be referred to as a conduction mode and a melt pool generated in this mode may be referred to as a conduction mode melt pool. It should be noted that other parameters (e.g., peak power, pulse frequency, pulse duration, etc.) may be used to generate conduction mode melt pools. In this case, the melt pools may be cyclically re-melted and annealed during subsequent layer deposition. With conduction mode, the melt pools may exhibit phases that approach thermodynamic equilibrium.

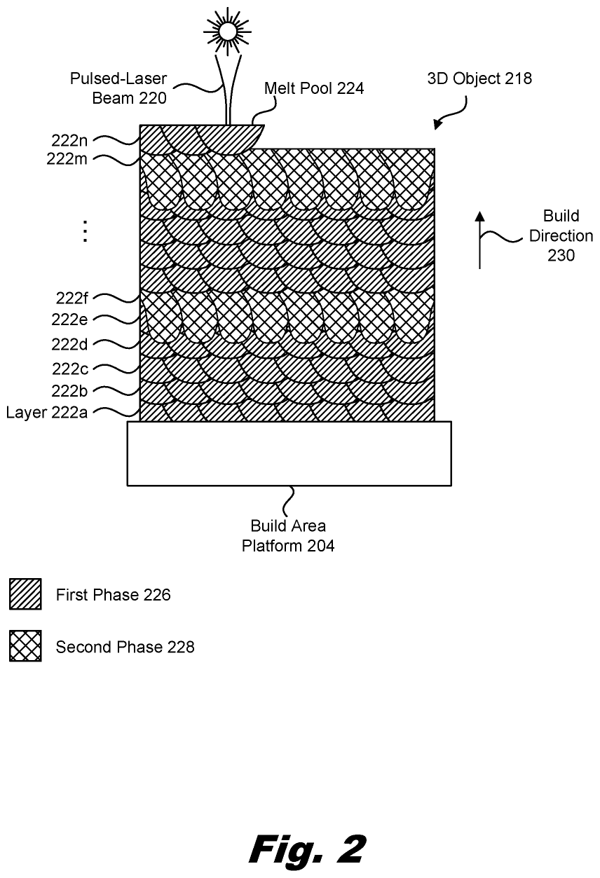

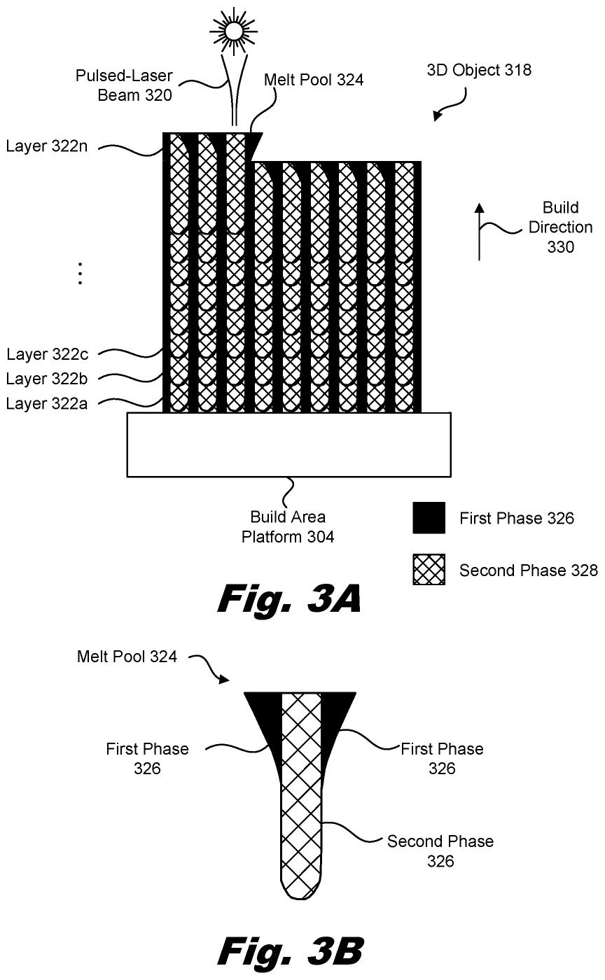

Depending on the spatial alignment of the different melt pool types (e.g., keyhole mode melt pool and conduction melt pool), microstructural changes and phase transformations may be induced both within a build layer and along the build direction. FIG. 2, FIG. 3A, and FIG. 3B illustrate examples of keyhole mode melt pools and conduction mode melt pools to control the phase within a 3D object.

Referring momentarily to FIG. 2, multiple layers 222a-n of a 3D object 218 are depicted. In this example, a first layer 222a is formed on a build area platform 204 by melting build material with a pulsed laser beam 220 in a number of melt pools 224. In this example, the first layer 222a may be formed with a first set of parameters (e.g., peak power, pulse frequency, pulse duration, and focal distance) for the pulsed laser beam 220. In this example, the pulsed laser beam 220 may be defocused in the first layer 222a to achieve shallow melt pools 224 with a first phase 226. This melt pools 224 with the first phase 226 may be conduction mode melt pools. In this example, the first set of parameters for the pulsed laser beam 220 may be used for four more layers 222b-e in the build direction 230 to form a band of melt pools with the first phase 226.

At the sixth layer 222f, the parameters of the pulsed laser beam 220 may be changed to generate keyhole mode melt pools 224. For example, the pulsed laser beam 220 may be focused to create melt pools 224 with a larger penetration depth compared to the melt pools 224 in conduction mode used to form the previous layers 222a-e. The melt pools 224 of the sixth layer 222f may have a second phase 228 upon cooling. With the focused pulsed laser beam 220, the melt pools 224 in the sixth layer 222f may penetrate through a number of layers below. In this example, the melt pools 224 in the sixth layer 222f penetrate through the two layers 222d-e below.

This melt pool pattern may be repeated. For example, a number of layers may be generated using the first set of parameters for the pulsed laser beam 220 to form a band of layers with the first phase 226. The parameters of the pulsed laser beam 220 may be changed to form another layer (e.g., layer 222m) in a keyhole mode resulting in melt pools 224 with the second phase 228. In this example, the melt pools 224 in keyhole mode are aligned in the build plane. The larger penetration depth of the melt pools 224 in keyhole mode compared to the melt pools 224 (e.g., in layers 222a-e) in conduction mode ensures the retention of a layer of material that includes metastable phases.

In the case of a carbon alloyed mild steel, the layerwise phase control of FIG. 2 may result in harder martensite dominated layers (e.g., layers 222f and 222m) surrounded by a softer bainitic and ferritic base microstructure (e.g., layers 222a-e). Evident in FIG. 2 is the control over the spacing between the martensite layers, which may vary from 2 to 5 layers (e.g., corresponding to 37 μm and 188 μm, respectively).

Referring now to FIG. 3A, multiple layers 322a-n of a 3D object 318 are depicted. In this example, a first layer 322a is formed on a build area platform 304 by melting build material with a pulsed laser beam 320 in a number of melt pools 324. In this example, the keyhole mode melt pools 324 are aligned out-of-plane. In other words, the keyhole mode melt pools 324 are aligned along the build direction 330 (e.g., along the z-axis). In this case, differential cooling rates are observed vertically giving rise to a lamellar microstructure that includes vertical walls of different phases.

FIG. 3B illustrates a single melt pool 324, according to an example. For a given melt pool 324, the second phase 328 may dominate the central, interior portion of the melt pool 324, while the first phase 326 may dominate peripheral portions of the melt pool 324.

In an example of FIG. 3A, the build material may include molybdenum alloyed austenitic stainless steel. In this case, the phase control results in two phases: ferrite (BCC) along the center of the melt pool 324 and austenite (FCC) on the outer melt pool area and overlapping melt pool regions.

It should be noted that in the example of FIGS. 3A and 3B, the melt pool pattern includes the melt pools 324 aligned in the build direction 330 such that a given melt pool 324 penetrates through multiple melt pools 324 in the layers below. The melt pool pattern in this example also includes spacing the melt pools 324 such that alternating vertical walls of the first phase 326 and the second phase 328 may form in the build direction 330. In this example, the parameters for the pulsed laser beam 320 may remain fixed for forming the multiple melt pools 324. However, the melt pool pattern (e.g., the spacing of the melt pools 324) may be adjusted to control the phase distribution in the 3D object 318.

Returning now to FIG. 1, as seen in the in-plane example of FIG. 2 and the out-of-plane example of FIG. 3A, phase control may be achieved by adjusting parameters for the pulsed laser 111 and/or adjusting the melt pool pattern. On the other hand, because the different melt pool types can be aligned arbitrarily within the 3D space of the 3D object 118, this method can be used to produce microstructures with complex 3D phase architectures. For example, different phases may be created within the 3D object 118. Some examples of the phase arrangement include a checkerboard structure, a grid structure, cellular structures with oblique struts formed by a given phase, etc.

The pulsed laser 111 may be controlled to form the 3D object 118 in an additive manufacturing process based on the determined parameters and the melt pool pattern. In this manner, the phase content in pLPBF alloys may be controlled both in-plane and out-of-plane by tuning the melt pool depth and cooling rate using different combinations of laser parameters (e.g., peak power, spot size, pulse frequency, and pulse duration). Therefore, the parameters for the pulsed laser 111 may be determined to control melt pool depth and melt pool cooling rate.

In some examples, the pulsed laser 111 may form a 3D object 118 with a heterogeneous structure. For example, different regions of the 3D object 118 may have mechanical properties based on the parameters used to generate melt pools in the different regions. A first region may have a first phase generated by a first melt pool type and a second region may have a second phase generated by a second melt pool type. In an example, the controller 120 may adjust parameters for the pulsed laser 111 to generate different melt pool types, where each melt pool type results in different phases of the build material 108, as described in FIG. 2. In this case, the parameters may be determined to produce given phases along a build plane (e.g., along the x-y plane) of the 3D object 118.

In another example, keyhole mode melt pools may be used to penetrate through multiple layers resulting in different phase types in different regions of the melt pool. These keyhole mode melt pools may be arranged in a melt pool pattern to form a controlled structure of varying phases. For example, the controller 120 may adjust parameters for the pulsed laser 111 to generate the melt pool pattern resulting in a lamellar structure along the build direction of the 3D object 118, as described in FIG. 3A. In this case, the parameters for the pulsed laser 111 may be determined to produce given phases in a build plane (e.g., along the z-axis) of the 3D object 118.

In some examples, the focus of the pulsed laser 111 may be changed during the LPBF process. Changing the laser focus may lead to a transition of the laser melting mode from keyhole mode to conduction mode. The resulting melt pool morphologies are conducive to variable cooling rates throughout the material and thus to the formation of different metastable phases (such as martensite in steel). Thus, site-specific phase control may be achieved by modulating the laser focus in the LPBF process and through adjustments of other parameters (e.g., peak power, pulse frequency, pulse duration, pulse location, pulse layer, etc.).

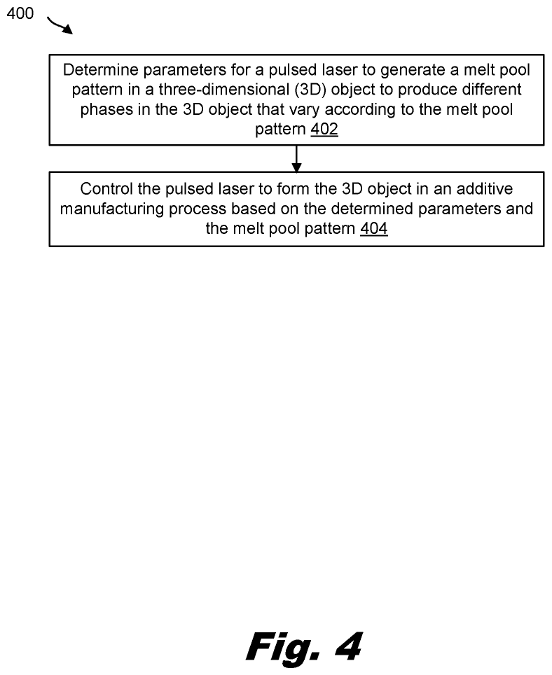

FIG. 4 is a flow diagram illustrating a method 400 for phase control in a build material, according to an example. In some examples, the method 400 may be performed by an additive manufacturing system, such as the additive manufacturing system 102 of FIG. 1.

At 402, parameters for a pulsed laser may be determined to generate a melt pool pattern in a 3D object to produce different phases in the 3D object that vary according to the melt pool pattern. The build material may include an alloy containing multiple phases. For example, the build material may be a powdered metal alloy (e.g., carbon steel, stainless steel, titanium, etc.).

In some examples, the parameters for the pulsed laser may include peak power, pulse frequency, pulse duration, and focal distance. The parameters may be determined to control melt pool depth and melt pool cooling rate. In some examples, the parameters are determined to produce given phases along a build plane of the 3D object. For example, this may be accomplished as described in FIG. 2. In some examples, the parameters may be determined to produce given phases in a build direction of the 3D object. This may be accomplished as described in FIG. 3A.

At 404, the pulsed laser may be controlled to form the 3D object in an additive manufacturing process based on the determined parameters and the melt pool pattern. In some examples, the pulsed laser may form the 3D object with a heterogeneous structure, where different regions of the 3D object have mechanical properties based on the parameters used to generate melt pools in the different regions.

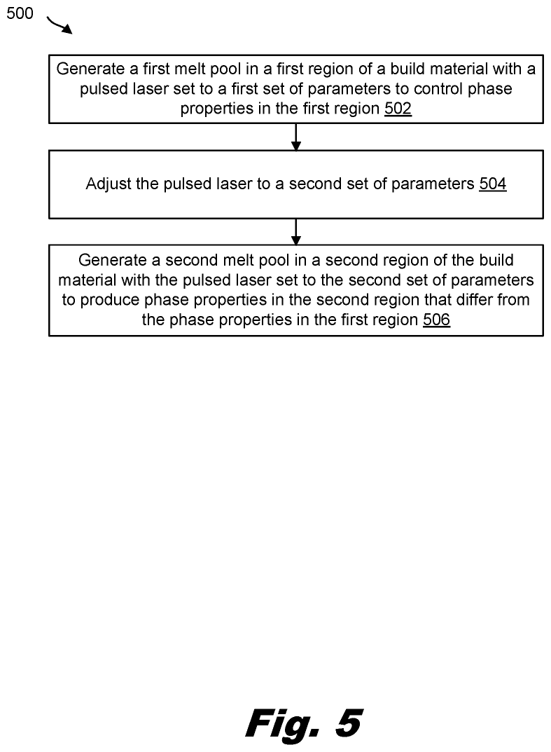

FIG. 5 is a flow diagram illustrating a method 500 for phase control in a build material, according to another example. In some examples, the method 500 may be performed by an additive manufacturing system, such as the additive manufacturing system 102 of FIG. 1.

At 502, a first melt pool may be generated in a first region of a build material with a pulsed laser set to a first set of parameters to control phase properties in the first region. For example, the pulsed laser may be set to a first focal length and a pulse of the pulsed laser may melt the build material to form the first melt pool. In another example, other parameters (e.g., peak power, pulse frequency, pulse duration) may be selected to form the first melt pool.

At 504, the pulsed laser may be adjusted to a second set of parameters. For example, the pulsed laser may be adjusted to a second focal length. Thus, adjusting the pulsed laser to the second set of parameters may include adjusting the focal length of the pulsed laser from the first focal length to the second focal length. In other examples, other parameters (e.g., peak power, pulse frequency, pulse duration) of the pulsed laser may be adjusted for the second set of parameters.

At 506, a second melt pool may be generated in a second region of the build material with the pulsed laser set to the second set of parameters. The phase properties produced in the second region may differ from the phase properties in the first region. The melt pool depth and cooling rate of the first melt pool may differ from the melt pool depth and cooling rate of the second melt pool. For example, the first melt pool may be a keyhole mode melt pool and the second melt pool may be a conduction mode melt pool.

In some examples, the first melt pool may include (e.g., may extend through) a plurality of layers in the first region of the build material. The second melt pool may include a single layer in the second region of the build material. In this case, the first set of parameters may be selected to control the phase properties in the plurality of layers in the first region of the build material, and the second set of parameters may be selected to control the phase properties in the single layer in the second region of the build material.

In some examples, the first melt pool and the second melt pool may be formed starting on different layers of the build material. In some examples, the first melt pool and the second melt pool may start on the same layer of the build material.

What is claimed is:

1. A method, comprising:
determining parameters for a pulsed laser to generate a melt pool pattern in a three-dimensional (3D) object to produce different phases in the 3D object that vary according to the melt pool pattern; and
controlling the pulsed laser to form the 3D object in an additive manufacturing process based on the determined parameters and the melt pool pattern.

2. The method of claim 1, wherein build material for the 3D object comprises an alloy containing multiple phases.

3. The method of claim 1, wherein the parameters for the pulsed laser comprise peak power, pulse frequency, pulse duration, and focal distance.

4. The method of claim 1, wherein the parameters are determined to control melt pool depth and melt pool cooling rate.

5. The method of claim 1, wherein the pulsed laser is to form the 3D object with a heterogeneous structure, wherein different regions of the 3D object have mechanical properties based on the parameters used to generate melt pools in the different regions.

6. The method of claim 1, wherein the parameters are determined to produce given phases along a build direction of the 3D object.

7. The method of claim 1, wherein the parameters are determined to produce given phases in a build plane of the 3D object.

8. A method, comprising:
generating a first melt pool in a first region of a build material with a pulsed laser set to a first set of parameters to control phase properties in the first region;
adjusting the pulsed laser to a second set of parameters; and
generating a second melt pool in a second region of the build material with the pulsed laser set to the second set of parameters to produce phase properties in the second region that differ from the phase properties in the first region.

9. The method of claim 8, wherein adjusting the pulsed laser to a second set of parameters comprises adjusting a focal length of the pulsed laser from a first focal length to a second focal length.

10. The method of claim 8, wherein a melt pool depth and cooling rate of the first melt pool differs from a melt pool depth and cooling rate of the second melt pool.

11. The method of claim 8, wherein the first melt pool comprises a plurality of layers in the first region of the build material, and wherein the second melt pool comprises a single layer in the second region of the build material.

12. The method of claim 11, wherein the first set of parameters are selected to control the phase properties in the plurality of layers in the first region of the build material, and wherein the second set of parameters are selected to control the phase properties in the single layer in the second region of the build material.

13. An additive manufacturing system, comprising:
a build material distributor;
a pulsed laser;
a controller; and
a non-transitory computer readable medium having stored thereon computer executable instructions to cause the controller to:
utilize the build material distributor to dispense the build material in a plurality of layers; and
control the pulsed laser to generate a melt pool pattern in the plurality of layers of the build material to form a three-dimensional (3D) object having different phases that vary according to the melt pool pattern.

14. The additive manufacturing system of claim 13, wherein the controller is to adjust parameters for the pulsed laser to generate the melt pool pattern resulting in a lamellar structure along a build direction of the 3D object.

15. The additive manufacturing system of claim 13, wherein the controller is to adjust parameters for the pulsed laser to generate different melt pool types, wherein each melt pool type results in different phases of the build material.
